(19) United States
(12) Patent Application Publication
(10) Pub. No.: US 2016/0077389 A1
(43) Pub. Date: Mar. 17, 2016

(54) LIQUID CRYSTAL DISPLAY DEVICE

(71) Applicant: Japan Display Inc., Minato-ku (JP)

(72) Inventors: Arihiro TAKEDA, Tokyo (JP); Hirokazu MORIMOTO, Tokyo (JP); Shoji HINATA, Tokyo (JP)

(73) Assignee: Japan Display Inc., Minato-ku (JP)

(21) Appl. No.: 14/826,327

(22) Filed: Aug. 14, 2015

(30) Foreign Application Priority Data
Sep. 12, 2014 (JP) 2014-186621

(51) Int. Cl. G02F 1/1343; G02F 1/1345; G02F 1/1335; G02F 1/1368; G02F 1/1362

(52) U.S. Cl. CPC G02F 1/134309; G02F 1/1368; G02F 1/136286; G02F 1/133512; G02F 1/13458; G02F 1/133514; G02F 2001/136218; G02F 2001/134318; G02F 2001/133519

(57) ABSTRACT

According to one embodiment, a liquid crystal display device includes a first substrate including a first insulative substrate, a gate line, a source line, a switching element, a pixel electrode, and a common electrode a second substrate including a second insulative substrate, a light shield layer disposed on that side of the second insulative substrate, which is opposed to the first substrate, and partitioning the pixels, and a shield electrode stacked on that side of the light shield layer, which is opposed to the first substrate, and formed of a metallic material, and a liquid crystal layer held between the first substrate and the second substrate.

### CROSS-REFERENCE TO RELATED APPLICATIONS

This application is based upon and claims the benefit of priority from Japanese Patent Application No. 2014-186621, filed Sep. 12, 2014, the entire contents of which are incorporated herein by reference.

### FIELD

Embodiments described herein relate generally to a liquid crystal display device.

### BACKGROUND

Various countermeasures to noise have been implemented in modern liquid crystal display devices. For example, a technique has been proposed, wherein an electrically conductive mesh electrode is disposed on an inner surface of a glass substrate, and this mesh electrode is grounded to a frame ground, thereby attenuating high-frequency noise.

### BRIEF DESCRIPTION OF THE DRAWINGS

FIG. 1 is a view which schematically illustrates a structure and an equivalent circuit of a liquid crystal display device according to an embodiment.

FIG. 2 is a plan view which schematically illustrates a structure example of a pixel PX at a time when an array substrate AR illustrated in FIG. 1 is viewed from a counter-substrate side.

FIG. 3 is a plan view which schematically illustrates an example of a layout of pixels, a light shield layer, color filters, and a shield electrode.

FIG. 4 is a cross-sectional view, taken along line A-B in FIG. 3, which schematically illustrates a cross-sectional structure of a liquid crystal display panel LPN.

FIG. 5 is a cross-sectional view, taken along line C-D in FIG. 3, which schematically illustrates a cross-sectional structure of the liquid crystal display panel LPN.

FIG. 6 is a plan view which schematically illustrates an example of a layout of a shield electrode SE, which is applicable to the embodiment.

FIG. 7 is a cross-sectional view, taken along line E-F in FIG. 6, which schematically illustrates an example of a connection state between the shield electrode SE and a pad 30.

FIG. 8 is a cross-sectional view, taken along line A-B in FIG. 3, which schematically illustrates another cross-sectional structure of the liquid crystal display panel LPN.

FIG. 9 is a cross-sectional view, taken along line A-B in FIG. 3, which schematically illustrates still another cross-sectional structure of the liquid crystal display panel LPN.

FIG. 10 is a cross-sectional view, taken along line A-B in FIG. 3, which schematically illustrates still another cross-sectional structure of the liquid crystal display panel LPN.

FIG. 11 is a cross-sectional view, taken along line C-D in FIG. 3, which schematically illustrates another cross-sectional structure of the liquid crystal display panel LPN.

FIG. 12 is a plan view which schematically illustrates another example of the shield electrode SE, which is applicable to the modification illustrated in FIG. 10 and FIG. 11.

FIG. 13 is a cross-sectional view which schematically illustrates the structure of a liquid crystal display device in a modification of the embodiment.

### DETAILED DESCRIPTION

In general, according to one embodiment, a liquid crystal display device includes: a first substrate including a first insulative substrate, a gate line extending in a first direction, a source line extending in a second direction crossing the first direction, a switching element electrically connected to the gate line and the source line, a pixel electrode disposed in each of pixels and electrically connected to the switching element, and a common electrode disposed over a plurality of pixels; a second substrate including a second insulative substrate, a light shield layer disposed on that side of the second insulative substrate, which is opposed to the first substrate, and partitioning the pixels, and a shield electrode stacked on that side of the light shield layer, which is opposed to the first substrate, and formed of a metallic material; and a liquid crystal layer held between the first substrate and the second substrate.

According to another embodiment, a liquid crystal display device includes: a first substrate including a first insulative substrate, a semiconductor layer, a first insulation film covering the semiconductor layer, a gate line extending in a first direction above the first insulation film, a second insulation film covering the gate line, a first common electrode formed above the second insulation film, a third insulation film covering the first common electrode, a source line extending in a second direction above the third insulation film, a fourth insulation film covering the source line, a pixel electrode including a main pixel electrode extending in the second direction above the fourth insulation film, and a second common electrode extending in the second direction above the fourth insulation film, including a second main common electrode opposed to the source line, and having the same potential as the first common electrode; a second substrate including a second insulative substrate, a light shield layer disposed on that side of the second insulative substrate, which is opposed to the first substrate, and partitioning the pixels, and a shield electrode stacked on that side of the light shield layer, which is opposed to the first substrate, and formed of a metallic material; and a liquid crystal layer held between the first substrate and the second substrate.

Embodiments will be described hereinafter with reference to the accompanying drawings. Incidentally, the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc. of the respective parts are schematically illustrated in the drawings, compared to the actual modes. However, the schematic illustration is merely an example, and adds no restrictions to the interpretation of the invention. Besides, in the specification and drawings, the structural elements having functions, which are identical or similar to the functions of the structural elements described in connection with preceding drawings, are denoted by like reference numerals, and an overlapping detailed description is omitted unless otherwise necessary.

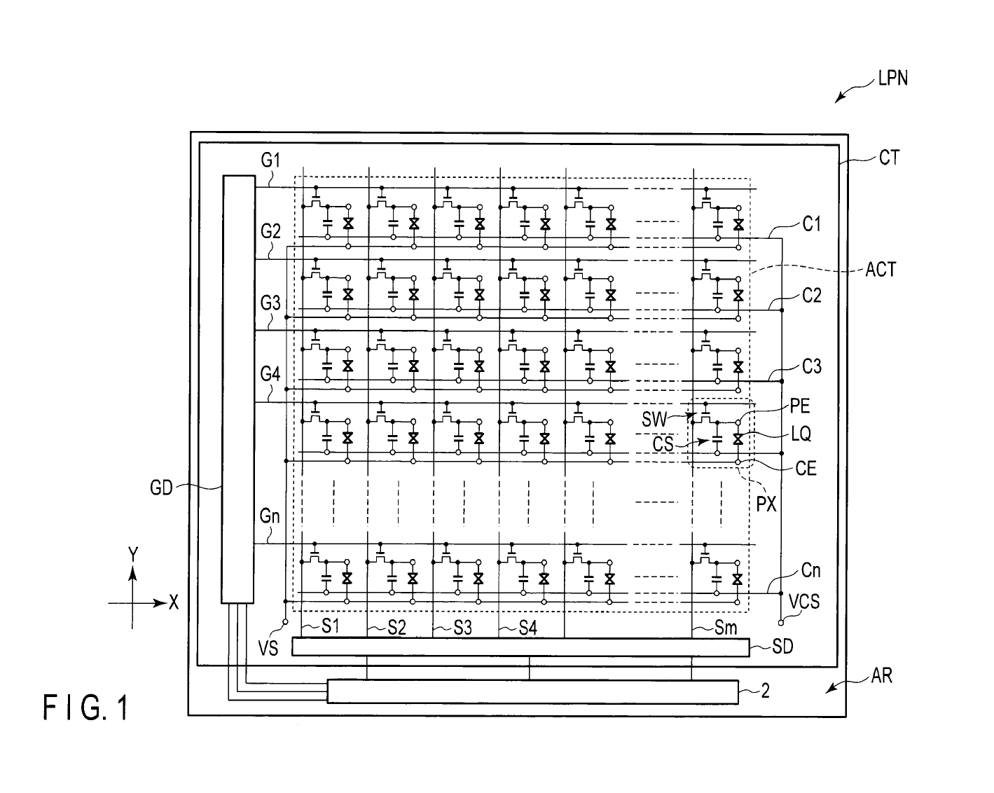

FIG. 1 is a view which schematically illustrates a structure and an equivalent circuit of a liquid crystal display device according to an embodiment.

The liquid crystal display device includes an active-matrix-type liquid crystal display panel LPN. The liquid crystal display panel LPN includes an array substrate AR which is a first substrate, a counter-substrate CT which is a second substrate that is disposed to be opposed to the array substrate AR, and a liquid crystal layer LQ which is held between the array substrate AR and the counter-substrate CT. The liquid crystal display panel LPN includes an active area ACT which displays an image. The active area ACT is composed of a plurality of pixels PX which are arrayed in a matrix.

The liquid crystal display panel LPN includes, in the active area ACT, a plurality of gate lines G (G1 to Gn), a plurality of storage capacitance lines C (C1 to Cn), and a plurality of source lines S (S1 to Sm). The gate lines G and storage capacitance lines C extend, for example, substantially linearly in a first direction X. The gate lines G and storage capacitance lines C neighbor at intervals in a second direction Y crossing the first direction X, and are alternately arranged in parallel. In this example, the first direction X and the second direction Y are perpendicular to each other. The source lines S extend substantially linearly in the second direction Y, and cross the gate lines G and storage capacitance lines C. In the meantime, the gate lines G, storage capacitance lines C and source lines S may not necessarily extend linearly, and portions thereof may be bent.

Each of the gate lines G is led out of the active area ACT and is connected to a gate driver GD. Each of the source lines S is led out of the active area ACT and is connected to a source driver SD. At least parts of the gate driver GD and source driver SD are formed on, for example, the array substrate AR. The gate driver GD and source driver SD are connected to a driving IC chip 2 which incorporates a controller.

Each of the pixels PX includes a switching element SW, a pixel electrode PE and a common electrode CE. A storage capacitance CS is formed, for example, between the storage capacitance line C and the pixel electrode PE (or a semiconductor layer having the same potential as the pixel electrode). The storage capacitance line C is electrically connected to a voltage application module VCS to which a storage capacitance voltage is applied.

The switching element SW is composed of, for example, an n-channel thin-film transistor (TFT). The switching element SW is electrically connected to the gate line G and source line S. The switching element SW may be of a top gate type or a bottom gate type.

The pixel electrodes PE are disposed in the respective pixels PX, and are electrically connected to the switching elements SW. The common electrode CE has, for example, a common potential, and is disposed over a plurality of pixels PX via the liquid crystal layer LQ. A power supply module VS is formed, for example, on the outside of the active area ACT on the array substrate AR. The common electrode CE is led out to the outside of the active area ACT, and is electrically connected to the power supply module VS.

In the present embodiment, the liquid crystal display panel LPN is configured such that the pixel electrodes PE are formed on the array substrate AR, and at least a part of the common electrode CE is formed on the array substrate AR or counter-substrate CT, and the alignment of liquid crystal molecules included in the liquid crystal layer LQ is controlled by mainly using an electric field which is produced between the pixel electrodes PE and the common electrode CE.

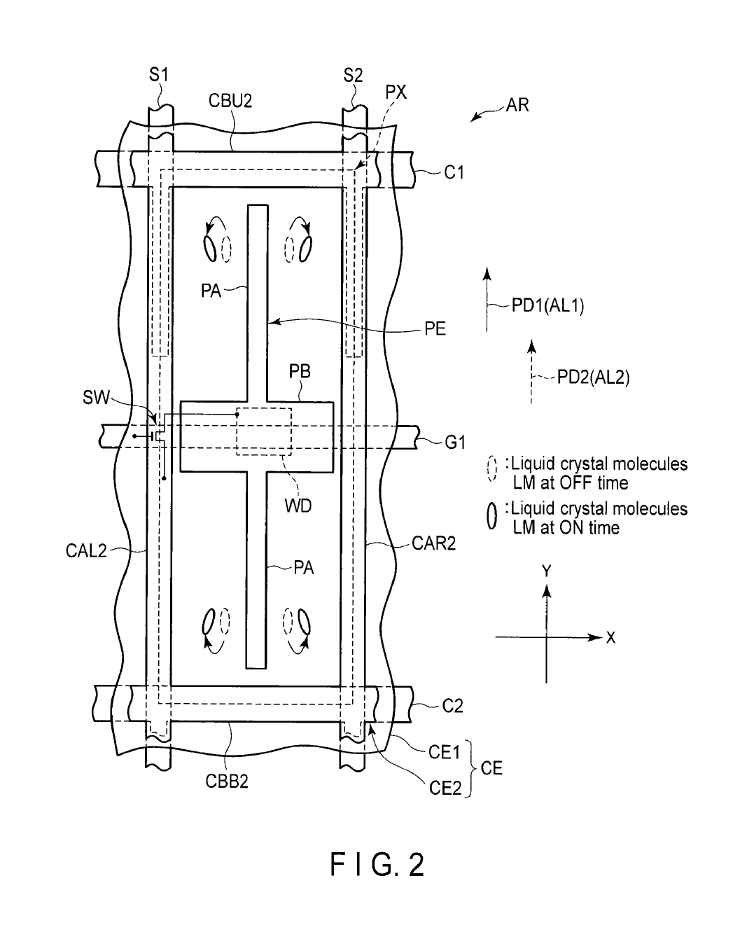

FIG. 2 is a plan view which schematically illustrates a structure example of a pixel PX at a time when the array substrate AR illustrated in FIG. 1 is viewed from the counter-substrate side. FIG. 2 is a plan view in an X-Y plane which is defined by the first direction X and second direction Y.

The array substrate AR includes a gate line G1, a storage capacitance line C1, a storage capacitance line C2, a source line S1, a source line S2, a switching element SW, a pixel electrode PE, a first common electrode CE1 and a second common electrode CE2 which are included in the common electrode CE, and a first alignment film AL1.

The storage capacitance line C1 and storage capacitance line C2 are disposed at an interval in the second direction Y, and each of the storage capacitance line C1 and storage capacitance line C2 extends in the first direction X. The gate line G1 is located between the storage capacitance line C1 and storage capacitance line C2, and extends in the first direction X. The source line S1 and source line S2 are disposed at an interval in the first direction X, and each of the source line S1 and source line S2 extends in the second direction Y.

In the example illustrated, as indicated by a broken line in FIG. 2, the pixel PX corresponds to a box-shaped area which is defined by the storage capacitance line C1 and storage capacitance line C2 and the source line S1 and source line S2, and has a rectangular shape having a less length in the first direction X than in the second direction Y. The length of the pixel PX in the first direction X corresponds to the pitch between the source line S1 and source line S2 in the first direction X. The length of the pixel PX in the second direction Y corresponds to the pitch between the storage capacitance line C1 and storage capacitance line C2 in the second direction Y.

In the pixel PX illustrated, the source line S1 is located at a left side end portion, and is disposed to extend over a boundary between the pixel PX and a pixel neighboring on the left side. The source line S2 is located at a right side end portion, and is disposed to extend over a boundary between the pixel PX and a pixel neighboring on the right side. The storage capacitance line C1 is located at an upper side end portion, and is disposed to extend over a boundary between the pixel PX and a pixel neighboring on the upper side. The storage capacitance line C2 is located at a lower side end portion, and is disposed to extend over a boundary between the pixel PX and a pixel neighboring on the lower side. The gate line G1 is disposed at a substantially middle portion of the pixel PX.

The switching element SW is electrically connected to the gate line G1 and source line S1. A drain electrode WD of the switching element SW is disposed at a substantially middle portion of the pixel PX.

The pixel electrode PE is located between the source line S1 and source line S2, and is located between the neighboring storage capacitance line C1 and storage capacitance line C2. The pixel electrode PE includes a main pixel electrode PA and a sub-pixel electrode PB. The main pixel electrode PA and sub-pixel electrode PB are formed integral or continuous, and are electrically connected to each other. The pixel electrode PE illustrated is formed in a cross shape.

The main pixel electrode PA is located at a substantially middle point between the source line S1 and source line S2, and linearly extends in the second direction Y to the vicinity of the upper side end portion of the pixel PX (i.e. to the vicinity of the storage capacitance line C1) and to the vicinity of the lower side end portion of the pixel PX (i.e. to the vicinity of the storage capacitance line C2). The main pixel electrode PA is formed in a strip shape having a substantially uniform width in the first direction X. The sub-pixel electrode PB is located between the storage capacitance line C1 and storage capacitance line C2. The sub-pixel electrode PB is formed to have a greater width in the first direction X than the main pixel electrode PA. A part of the sub-pixel electrode PB is disposed at a position overlapping the gate line G1, and the sub-pixel electrode PB overlaps the drain electrode WD and is electrically connected to the switching element SW.

The first common electrode CE1 is opposed to the pixel electrode PE, and is disposed over substantially the entirety of the pixel PX. In addition, the first common electrode CE1 is opposed to the source line S1 and source line S2, extends in the first direction X beyond the source line S1 and source line S2, and is also disposed on pixels neighboring the pixel PX in the first direction X. Besides, the first common electrode CE1 is opposed to the gate line G1, storage capacitance line C1 and storage capacitance line C2, extends in the second direction Y beyond the storage capacitance line C1 and storage capacitance line C2, and is also disposed on pixels neighboring the pixel PX in the second direction Y.

The second common electrode CE2 includes a second main common electrode CAL2 and a second main common electrode CAR2, and a second sub-common electrode CBU2 and a second sub-common electrode CBB2. The second main common electrode CAL2 and second main common electrode CAR2, and the second sub-common electrode CBU2 and second sub-common electrode CBB2 are formed integral or continuous, and are electrically connected to each other. Specifically, the second common electrode CE2 is formed in a grid shape which partitions the pixel PX. The second common electrode CE2 is spaced apart from the pixel electrode PE, and surrounds the pixel electrode PE. The first common electrode CE1 and second common electrode CE2 are electrically connected to each other, have the same potential, and are connected to the power supply module VS on the outside of the active area ACT.

Each of the second main common electrode CAL2 and second main common electrode CAR2 linearly extends in the second direction Y, and is formed in a strip shape. In the example illustrated, the second main common electrode CAL2 is located at a left side end portion of the pixel PX, is disposed to extend over a boundary between the pixel PX and a pixel neighboring on the left side, and is opposed to the source line S1. The second main common electrode CAR2 is located at a right side end portion of the pixel PX, is disposed to extend over a boundary between the pixel PX and a pixel neighboring on the right side, and is opposed to the source line S2.

Each of the second sub-common electrode CBU2 and second sub-common electrode CBB2 linearly extends in the first direction X, and is formed in a strip shape. In the example illustrated, the second sub-common electrode CBU2 is located at an upper side end portion of the pixel PX above the storage capacitance line C1, and is disposed to extend over a boundary between the pixel PX and a pixel neighboring on the upper side. The second sub-common electrode CBB2 is located at a lower side end portion of the pixel PX above the storage capacitance line C2, and is disposed to extend over a boundary between the pixel PX and a pixel neighboring on the lower side.

In the array substrate AR, the pixel electrode PE and second common electrode CE2 are covered with the first alignment film AL1. The first alignment film AL1 is subjected to alignment treatment in a first alignment treatment direction PD1 for initially aligning the liquid crystal molecules of the liquid crystal layer LQ. The first alignment treatment direction PD1 is substantially parallel to the second direction Y.

In the meantime, a second alignment film AL2, which will be described later, is subjected to alignment treatment in a second alignment treatment direction PD2. The second alignment treatment direction PD2 is parallel to the first alignment treatment direction PD1. In the example illustrated, the second alignment treatment direction PD2 is identical to the first alignment treatment direction PD1. Incidentally, the first alignment treatment direction PD1 and second alignment treatment direction PD2 may be opposite to each other.

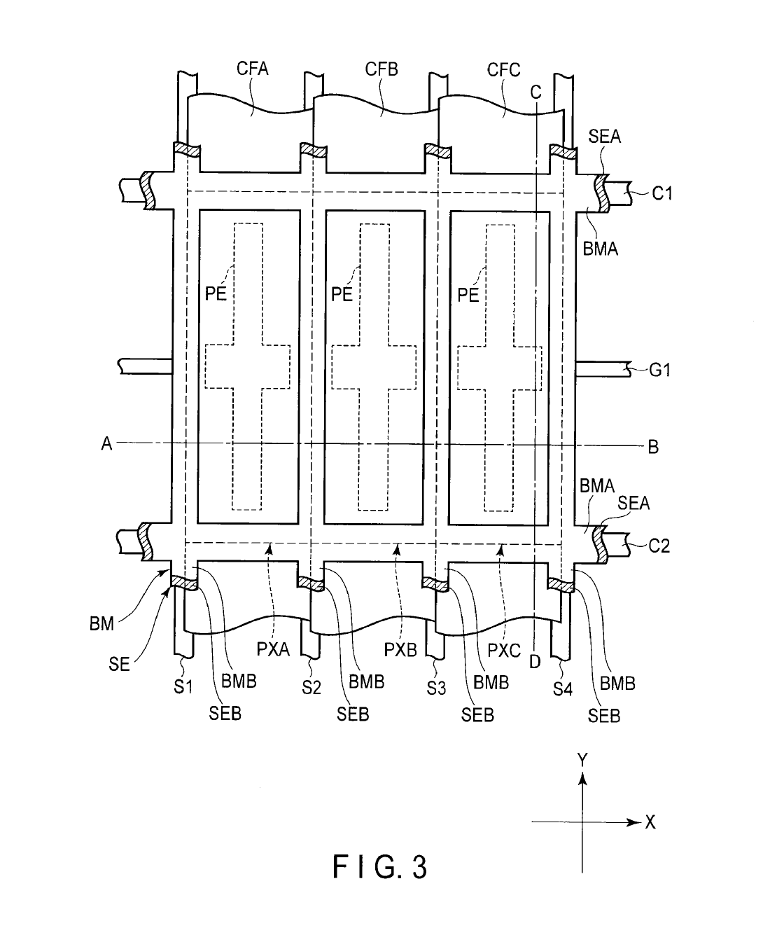

FIG. 3 is a plan view which schematically illustrates an example of a layout of pixels, a light shield layer, color filters, and a shield electrode. FIG. 3 is a plan view in the X-Y plane.

A pixel PXA is defined by storage capacitance lines C1 and C2 and source lines S1 and S2. A pixel PXB is defined by the storage capacitance lines C1 and C2, the source line S2 and a source line S3. A pixel PXC is defined by the storage capacitance lines C1 and C2, the source line S3 and a source line S4. The pixel PXA, pixel PXB and pixel PXC are arranged in the named order in the first direction X. As has been described with reference to FIG. 2, each of the pixel PXA, pixel PXB and pixel PXC has a rectangular shape extending in the second direction Y, and is formed in the same size. In the example illustrated, the pixel PXA, pixel PXB and pixel PXC are pixels which display different colors. A pixel electrode PE is disposed in each of the pixel PXA, pixel PXB and pixel PXC.

A light shield layer BM is disposed in a manner to partition the pixel PXA, pixel PXB and pixel PXC. Specifically, the light shield layer BM includes first portions BMA extending in the first direction X, and second portions BMB extending in the second direction Y, and is formed in a grid shape. The light shield layer BM forms a rectangular aperture portion extending in the second direction Y in each of the pixel PXA, pixel PXB and pixel PXC. In the example illustrated, in the light shield layer BM, the first portions BMA are located above the storage capacitance lines C1 and C2, respectively. In addition, in the light shield layer BM, the second portions BMB are located above the source lines S1 to S4, respectively. Incidentally, the light shield layer BM may be formed in stripe shapes located only above the source lines. In addition, in the light shield layer BM, the first portion BMA may be located above a gate line G1.

A color filter CFA, a color filter CFB and a color filter CFC are arranged in the named order in the first direction X. Each of the color filter CFA, color filter CFB and color filter CFC extends in the second direction Y, and is formed in a strip shape.

For example, the color filter CFA is a color filter of red (R), the color filter CFB is a color filter of green (G), and the color filter CFC is a color filter of blue (B). The color filter CFA is disposed in association with the pixel (red pixel) PXA. The color filter CFB is disposed in association with the pixel (green pixel) PXB. The color filter CFC is disposed in association with the pixel (blue pixel) PXC. The color filter CFA, color filter CFB and color filter CFC have their end portions overlapping the light shield layer BM. In the meantime, in addition to the above-described color filters of the three colors, a color filter of a color (e.g. transparent or white) other than the red, blue and green may further be disposed.

A shield electrode SE is stacked on the light shield layer BM. As indicated by hatching in FIG. 3, the shield electrode SE is formed, for example, in the same shape as the light shield layer BM, and is formed continuous over substantially the entirety of the light shield layer BM. Specifically, the shield electrode SE includes first portions SEA extending in the first direction X, and second portions SEB extending in the second direction Y, and is formed in a grid shape. The first portions SEA of the shield electrode SE are stacked on the first portions BMA of the light shield layer BM, and the second portions SEB of the shield electrode SE are stacked on the second portions BMB of the light shield layer BM. In the example illustrated, in the X-Y plane, the shield electrode SE is formed in a grid shape surrounding the pixel electrode PE. In the shield electrode SE, the first portions SEA are located above the storage capacitance lines C1 and C2, respectively. In addition, in the shield electrode SE, the second portions SEB are located above the source lines S1 to S4, respectively. Incidentally, the shield electrode SE may be formed in stripe shapes located only above the source lines, or in stripe shapes located only above the storage capacitance lines, or in a stripe shape located only above the gate line. It is not always necessary that the width of the shield electrode SE be equal to the width of the light shield layer BM.

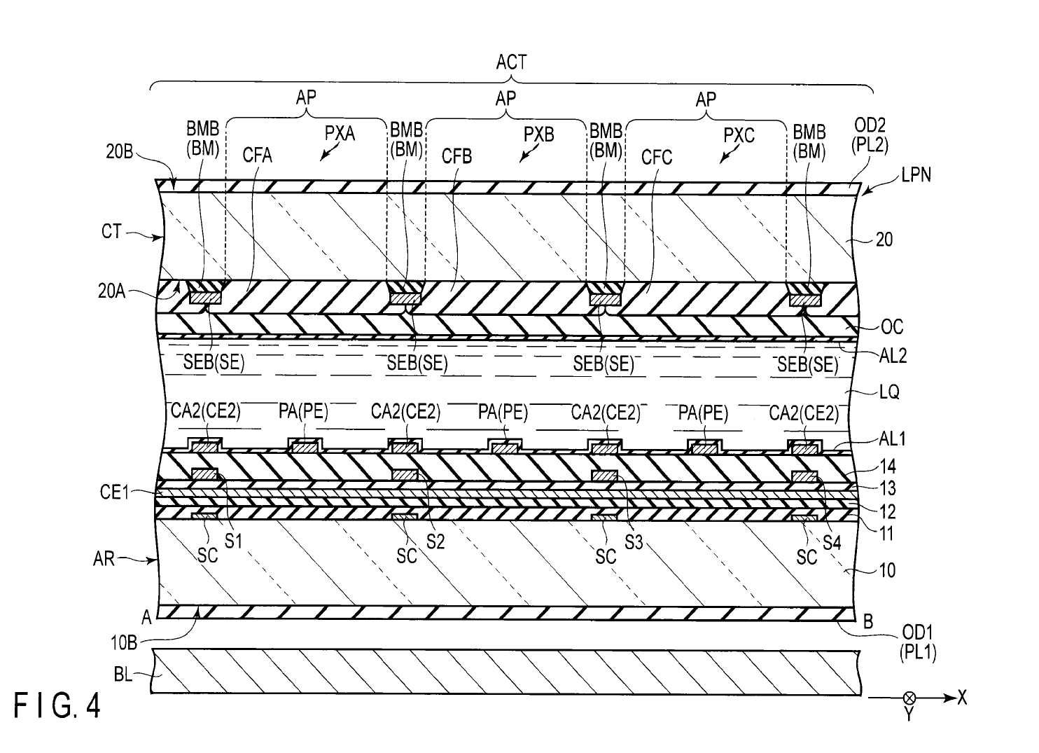

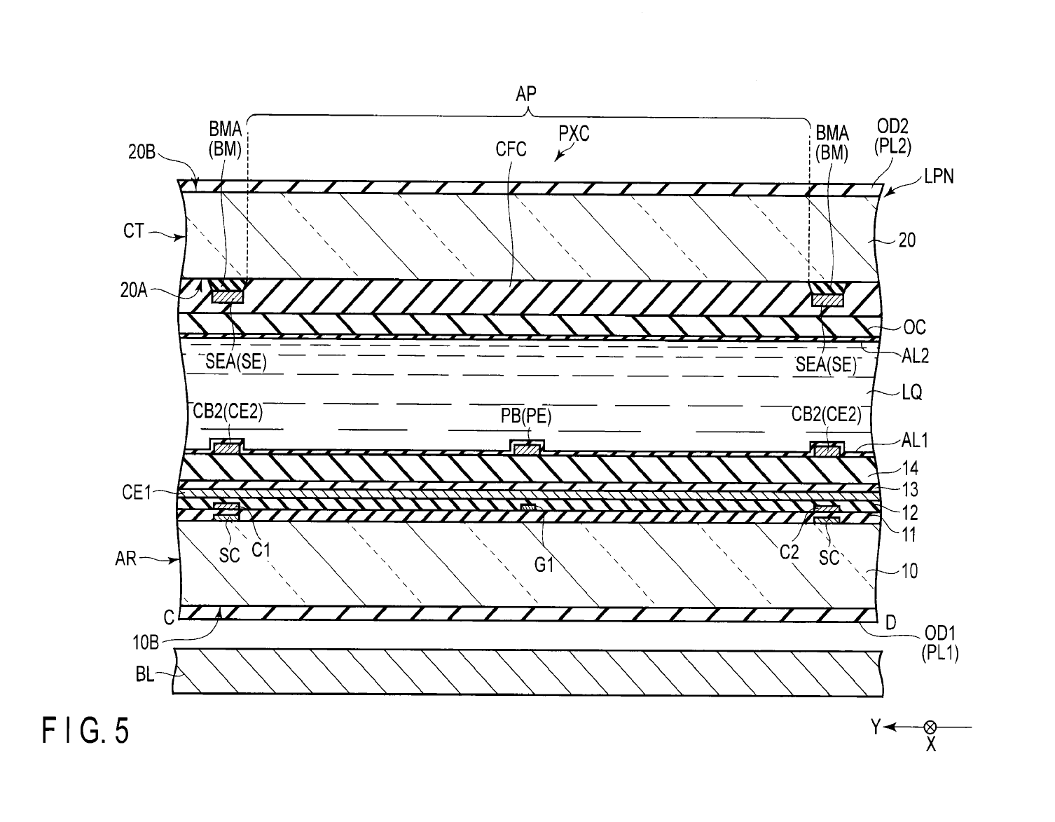

FIG. 4 is a cross-sectional view, taken along line A-B in FIG. 3, which schematically illustrates a cross-sectional structure of the liquid crystal display panel LPN. FIG. 5 is a cross-sectional view, taken along line C-D in FIG. 3, which schematically illustrates a cross-sectional structure of the liquid crystal display panel LPN.

A backlight unit BL, which illuminates the liquid crystal display panel LPN, is disposed on the back side of the array substrate AR. Various modes are applicable to the backlight unit BL. A description of the detailed structure of the backlight unit BL is omitted here.

The array substrate AR is formed by using a first insulative substrate 10 having light transmissivity. The array substrate AR includes, on the inside of the first insulative substrate 10, that is, on the side facing the counter-substrate CT, semiconductor layers SC of switching elements, a gate line G1, a storage capacitance line C1, a storage capacitance line C2, a source line S1, a source line S2, a source line S3, a source line S4, pixel electrodes PE, a first common electrode CE1, a second common electrode CE2, a first insulation film 11, a second insulation film 12, a third insulation film 13, a fourth insulation film 14, and a first alignment film AL1.

The semiconductor layers SC are formed on the first insulative substrate 10 and are covered with first insulation film 11. The semiconductor layer SC is formed of, for example, polycrystalline silicon (p-Si), but it may be formed of amorphous silicon (a-Si). In the meantime, an insulation film (undercoat layer) may be additionally provided between the semiconductor layer SC and first insulative substrate 10. The storage capacitance line C1, storage capacitance line C2 and gate line G1 are formed on the first insulation film 11, and are covered with the second insulation film 12. The storage capacitance line C1 and storage capacitance line C2 are opposed to the semiconductor layers SC via the first insulation film 11.

The first common electrode CE1 is formed on the second insulation film 12, and is covered with the third insulation film 13. The first common electrode CE1 is formed of a transparent, electrically conductive material such as indium tin oxide (ITO) or indium zinc oxide (IZO). The first common electrode CE1 is opposed to the semiconductor layers SC via the first insulation film 11 and second insulation film 12, and is also opposed to the gate line G1, storage capacitance line C1 and storage capacitance line C2 via the second insulation film 12.

The source lines S1 to S4 are formed on the third insulation film 13 and are covered with the fourth insulation film 14. The first common electrode CE1 lies between the semiconductor layers SC and the source lines S1 to S4.

The above-described first insulation film 11, second insulation film 12 and third insulation film 13 are formed of a transparent, inorganic material such as silicon nitride or silicon oxide. The fourth insulation film 14 is formed of a transparent, organic material such as a resin material.

The second common electrode CE2 and pixel electrodes PE are formed on the fourth insulation film 14 and are covered with the first alignment film AL1. The second common electrode CE2 and pixel electrodes PE can be formed of the same material at a time, and are formed of, for example, a transparent, electrically conductive material such as ITO or IZO. Incidentally, the pixel electrodes PE and second common electrode CE2 may be formed of an opaque wiring material such as aluminum (Al), titanium (Ti), silver (Ag), molybdenum (Mo), tungsten (W), copper (Cu) or chromium (Cr). The main pixel electrode PA is located between the second main common electrodes CA2, and is opposed to the first common electrode CE1 via the third insulation film 13 and fourth insulation film 14. The sub-pixel electrode PB is located between the second sub-common electrodes CB2, and is opposed to the first common electrode CE1 via the third insulation film 13 and fourth insulation film 14. The second main common electrodes CA2 are opposed to the source lines S1 to S4, respectively, via the fourth insulation film 14. The second sub-common electrodes CB2 are opposed, above the storage capacitance lines C1 and C2, to the first common electrode CE1 via the third insulation film 13 and fourth insulation film 14.

The first alignment film AL1 is disposed on that surface of the array substrate AR, which is opposed to the counter-substrate CT, and the first alignment film AL1 extends over substantially the entirety of the active area ACT. The first alignment film AL1 is also disposed on the fourth insulation film 14. The first alignment film AL1 is formed of, for example, a material which exhibits horizontal alignment properties.

The counter-substrate CT is formed by using a second insulative substrate 20 having light transmissivity. The counter-substrate CT includes a light shield layer BM, a shield electrode SE, a color filter CFA, a color filter CFB, a color filter CFC, an overcoat layer OC, and a second alignment film AL2, on the inside of the second insulative substrate 20, that is, on that side of the second insulative substrate 20, which is opposed to the array substrate AR.

The light shield layer BM partitions the pixel PXA, pixel PXB and pixel PXC, and forms aperture portions AP which are opposed to the pixel electrodes PE. Specifically, the light shield layer matrix BM is disposed so as to be opposed to wiring portions, such as the source lines S1 to S4 and storage capacitance lines C1 and C2. In the example illustrated, first portions BMA of the light shield layer BM are located above the storage capacitance lines C1 and C2, or above the second sub-common electrodes CB2. In addition, second portions BMB of the light shield layer BM are located above the source lines S1 to S4, or above the second main electrodes CA2. The light shield layer BM is disposed on an inner surface 20A of the second insulative substrate 20, which is opposed to the array substrate AR. The light shield layer BM is formed of a resin material which is colored in black.

The shield electrode SE is stacked on that side of the light shield layer BM, which is opposed to the array substrate AR. In the example illustrated, first portions SEA of the shield electrode SE are stacked on the array substrate AR side of the first portions BMA of the light shield layer BM, and are opposed to the second sub-common electrodes CB2. In addition, second portions SEB of the shield electrode SE are stacked on the array substrate AR side of the second portions BMB of the light shield layer BM, and are opposed to the second main electrodes CA2. The shield electrode SE is formed of a metallic material having a lower resistance than a transparent, electrically conductive material. For example, the shield electrode SE is formed of a metallic material such as aluminum (Al), titanium (Ti), or silver (Ag).

The color filter CFA, color filter CFB and color filter CFC are disposed in inside portions (aperture portions AP) partitioned by the light shield layer BM on the inner surface 20A of the second insulative substrate 20, and parts of these color filters overlap the light shield layer BM or shield electrode SE. The color filter CFA is formed of, for example, a resin material that is colored in red, is disposed in association with the pixel PXA. The color filter CFB is formed of, for example, a resin material that is colored in green, is disposed in association with the pixel PXB. The color filter CFC is formed of, for example, a resin material that is colored in blue, is disposed in association with the pixel PXC.

The overcoat layer OC covers the color filter CFA, color filter CFB and color filter CFC. The overcoat layer OC is formed of, for example, a transparent resin material.

In the above-described aperture portion AP, in regions between the pixel electrode PE and the second common electrode CE2, excluding a region crossing the gate line G1, no other electrode or wiring is formed, and these regions correspond to transmissive regions through which backlight can pass.

The second alignment film AL2 is disposed on that surface of the counter-substrate CT, which is opposed to the array substrate AR, and the second alignment film AL2 extends over substantially the entirety of the active area ACT. The second alignment film AL2 covers the overcoat layer OC. The second alignment film AL2 is formed of, for example, a material which exhibits horizontal alignment properties.

The above-described array substrate AR and counter-substrate CT are disposed such that their first alignment film AL1 and second alignment film AL2 are opposed to each other. In this case, columnar spacers, which are formed of, e.g. a resin material so as to be integral to one of the array substrate AR and counter-substrate CT, are disposed between the array substrate AR and the counter-substrate CT. Thereby, a predetermined cell gap is created between the first alignment film AL1 and second alignment film AL2. The cell gap is, for example, 2 to 7 μm. The array substrate AR and counter-substrate CT are attached by a sealant on the outside of the active area ACT in the state in which the predetermined cell gap is created therebetween.

The liquid crystal layer LQ is held between the array substrate AR and the counter-substrate CT, and is disposed between the first alignment film AL1 and second alignment film AL2.

A first optical element OD1 is attached to an outer surface 10B of the first insulative substrate 10. The first optical element OD1 is located on that side of the liquid crystal display panel LPN, which is opposed to the backlight unit BL, and controls the polarization state of incident light which enters the liquid crystal display panel LPN from the backlight unit BL. The first optical element OD1 includes a first polarizer PL1 having a first polarization axis AX1. In the meantime, another optical element, such as a retardation plate, may be disposed between the first polarizer PL1 and the first insulative substrate 10.

A second optical element OD2 is attached to an outer surface 20B of the second insulative substrate 20. The second optical element OD2 is located on the display surface side of the liquid crystal display panel LPN, and controls the polarization state of emission light emerging from the liquid crystal display panel LPN. The second optical element OD2 includes a second polarizer PL2 having a second polarization axis AX2. In the meantime, another optical element, such as a retardation plate, may be disposed between the second polarizer PL2 and the second insulative substrate 20.

The first polarization axis AX1 and the second polarization axis AX2 have a substantially orthogonal positional relationship of crossed Nicols. In an example, the first polarization axis AX1 is parallel to the first direction X, and the second polarization axis AX2 is parallel to the second direction Y. Alternatively, the second polarization axis AX2 is parallel to the first direction X, and the first polarization axis AX1 is parallel to the second direction Y.

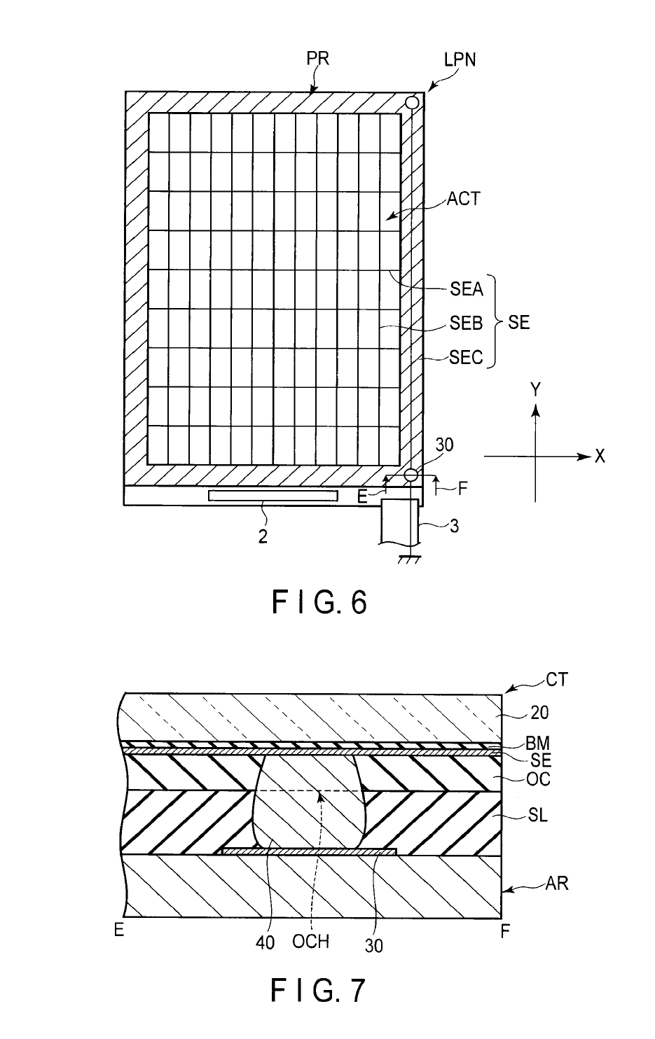

FIG. 6 is a plan view which schematically illustrates an example of a layout of the shield electrode SE, which is applicable to the embodiment.

As described above, in the active area ACT, the shield electrode SE includes the first portions SEA and second portions SEB and is formed in a grid shape. In addition, in a peripheral area PR surrounding the active area ACT, the shield electrode SE includes a third portion SEC which is formed in a rectangular frame shape, as indicated by hatching in FIG. 6. In the peripheral area PR, the shield electrode SE is electrically connected to a pad 30 of a ground potential. In the example illustrated, the pad 30 is grounded via a flexible printed circuit board 3.

FIG. 7 is a cross-sectional view, taken along line E-F in FIG. 6, which schematically illustrates an example of a connection state between the shield electrode SE and the pad 30.

The array substrate AR includes the pad 30 on the side thereof facing the counter-electrode CT. In the counter-substrate CT, the light shield layer BM, shield electrode SE and overcoat layer OC are stacked in the named order on that side of the second insulative substrate 20, which is opposed to the array substrate AR. In the overcoat layer OC, a through-hole OCH, which penetrates to the shield electrode SE, is formed at a position opposed to the pad 30. An electrically conductive member 40 is disposed in the through-hole OCH, and electrically connects the pad 30 and shield electrode SE. Incidentally, in the example illustrated, the electrically conductive member 40 is located in the inside of a sealant SL which attaches the array substrate AR and counter-substrate CT, but the conductive member 40 may be located outside the sealant SL.

Next, the operation of the liquid crystal display panel LPN with the above-described structure is described.

Specifically, in a state in which no voltage is applied to the liquid crystal layer LQ, that is, in a state (OFF time) in which no electric field is produced between the pixel electrode PE and common electrode CE, liquid crystal molecules LM of the liquid crystal layer LQ are initially aligned, as indicated by broken lines in FIG. 2, such that the major axes thereof are initially aligned substantially parallel to the second direction Y in the X-Y plane. This OFF time corresponds to the initial alignment state, and the alignment direction (the second direction Y in this example) of the liquid crystal molecules LM at the OFF time corresponds to the initial alignment direction.

At this OFF time, part of light from the backlight unit BL passes through the first polarizer PL1, and enters the liquid crystal display panel LPN. The light, which has entered the liquid crystal display panel LPN, is linearly polarized light which is perpendicular to the first polarization axis AX1 of the first polarizer PL1. The polarization state of linearly polarized light hardly varies when the light passes through the liquid crystal layer LQ at the OFF time. Thus, the linearly polarized light, which has passed through the liquid crystal display panel LPN, is absorbed by the second polarizer PL2 that is in the positional relationship of crossed Nicols in relation to the first polarizer PL1 (black display).

On the other hand, in a state in which a voltage is applied to the liquid crystal layer LQ, that is, in a state (ON time) in which an electric field is produced between the pixel electrode PE and the common electrode CE, an electric field, which is substantially parallel to the substrate major surface, is produced between the pixel electrode PE and the second common electrode CE2. The liquid crystal molecules LM are affected by the electric field between the pixel electrode PE and common electrode CE, and the polarization state thereof varies. In the example illustrated in FIG. 2, in the region between the pixel electrode PE and second main common electrode CAL2, the liquid crystal molecule LM in a lower-half region rotates clockwise relative to the second direction Y, and is aligned in a lower left direction in the Figure, and the liquid crystal molecule LM in an upper-half region rotates counterclockwise relative to the second direction Y, and is aligned in an upper left direction in the Figure. In the region between the pixel electrode PE and second main common electrode CAR2, the liquid crystal molecule LM in a lower-half region rotates counterclockwise relative to the second direction Y, and is aligned in a lower right direction in the Figure, and the liquid crystal molecule LM in an upper-half region rotates clockwise relative to the second direction Y, and is aligned in an upper right direction in the Figure. In this manner, in each pixel PX, the liquid crystal molecules LM at the ON time are aligned in a plurality of directions, with boundaries at positions overlapping the pixel electrodes PE, and domains are formed in the respective alignment directions. Specifically, a plurality of domains are formed in one pixel PX. Thereby, in the pixel PX, transmissive regions, through which backlight can pass, are formed between the pixel electrode PE and the common electrode CE.

At this ON time, the polarization state of linearly polarized light, which has entered the liquid crystal display panel LPN, varies depending on the alignment state of the liquid crystal molecules LM when the light passes through the liquid crystal layer LQ. Thus, at the ON time, at least part of the light emerging from the liquid crystal layer LQ passes through the second polarizer PL2 (white display). However, at a position overlapping the pixel electrode PE and common electrode CE, since the liquid crystal molecules LM maintain the initial alignment state, black display is effected, like the case of the OFF time.

Meanwhile, when the liquid crystal display panel LPN operates, driving noise occurs within the liquid crystal display panel LPN. The driving noise, in this context, corresponds to, for example, noise occurring due to a video signal that is supplied to the source line S and a control signal that is supplied to the gate line G, or due to the operation of the switching element SW. Such driving noise is shielded by the shield electrode SE which is electrically connected to the pad 30 of the ground potential, and can be prevented from leaking to the outside of the liquid crystal display panel LPN.

According to the present embodiment, even if driving noise occurs within the liquid crystal display panel LPN, the driving noise can be shielded by the shield electrode SE which is disposed on the counter-substrate CT that is located on the display surface side. Thus, in an electronic apparatus in which the liquid crystal display panel LPN of the present embodiment is combined with peripheral equipment such as a touch panel, a communication antenna or a television receiver antenna, it becomes possible to suppress malfunction of the peripheral equipment due to driving noise.

Moreover, since the shield electrode SE is formed of a metallic material with a relatively low resistance, the driving noise can be quickly decreased. In addition, since the shield electrode SE is stacked on the light shield layer BM which does not contribute to display in the active area ACT, even if the shield electrode SE is formed of a light-shielding metallic material, it is possible to suppress a decrease in transmissive area of each pixel, regardless of the area of disposition of the shield electrode SE. Besides, the shield electrode SE is stacked on that side of the light shield layer BM, which is opposed to the array substrate AR. Specifically, the light shield layer BM lies on the display surface side (or the second insulative substrate side) of the shield electrode SE. Thus, even if the shield electrode SE is formed of a metallic material with a relatively high reflectance, ambient light from the display surface side is absorbed by the light shield layer BM, and reflection by the shield electrode SE can be suppressed. Thereby, even under ambient light, degradation of display quality due to the effect of ambient light can be suppressed.

Furthermore, according to the present embodiment, the array substrate AR includes, as the common electrode, the first common electrode CE1 which is located on the first insulative substrate 10 side of the source lines S, and the second main common electrode CA2 which is located on the liquid crystal layer LQ side of the source lines S. Since the first common electrode CE1 and the second main common electrode CA2 have the same potential, an equipotential surface is formed between the first common electrode CE1 and the second main common electrode CA2. This equipotential surface shields driving noise occurring from the source lines S, which is located between the first common electrode CE1 and the second main common electrode CA2, toward the liquid crystal layer LQ or the first insulative substrate 10, and also shields an undesired leak electric field occurring from the source lines S toward the liquid crystal layer LQ. Accordingly, the shield effect of driving noise can further be enhanced. In addition, the effect of an undesired electric field in regions near the source lines S, among the transmissive regions, can be reduced, and the display quality can be improved.

Additionally, the first common electrode CE1 is opposed to the gate line G. Thus, an undesired leak electric field from the gate line G toward the liquid crystal layer LQ can be shielded. Therefore, the effect of an undesired electric field in regions near the gate line G, among the transmissive regions, can be reduced, and the display quality can be improved.

Next, modifications of the present embodiment will be described. In the description below, main different points will be described, and the same structures as in the above-described examples are denoted by like reference numerals, and a detailed description thereof is omitted.

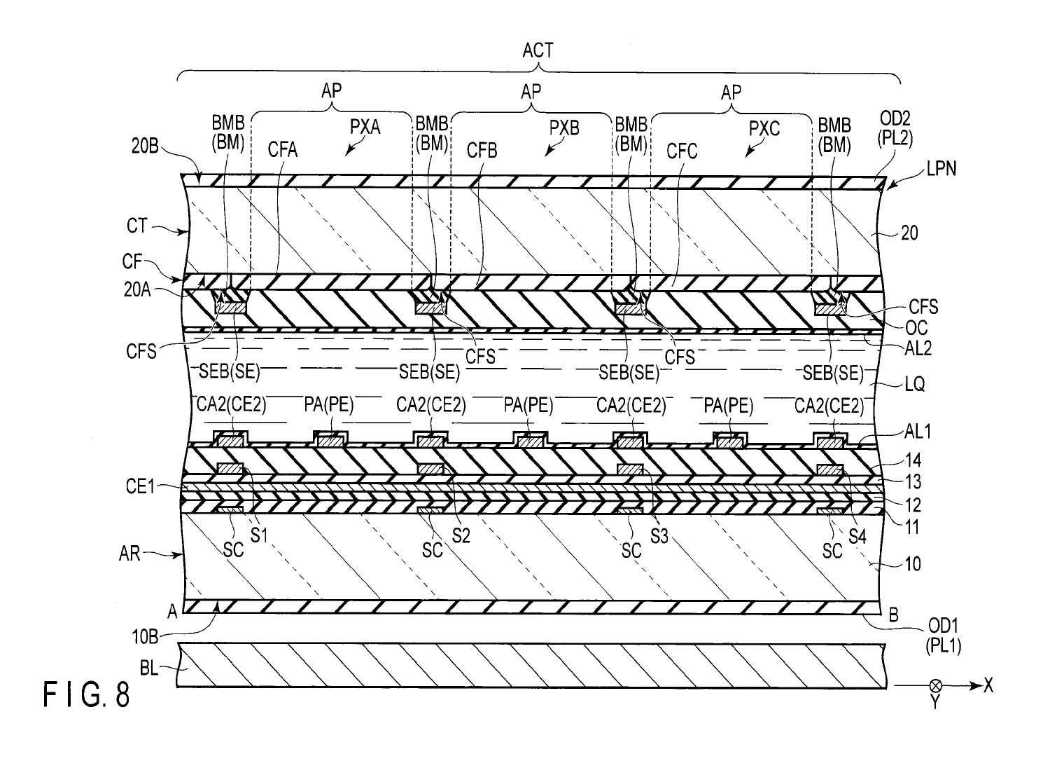

FIG. 8 is a cross-sectional view, taken along line A-B in FIG. 3, which schematically illustrates another cross-sectional structure of the liquid crystal display panel LPN.

The example illustrated in FIG. 8 differs from the example in FIG. 4 in that the multilayer structure of the light shield layer BM and shield electrode SE is disposed between the color filter CF and the overcoat layer OC.

Specifically, the light shield layer BM is disposed on an inner surface CFS of the color filter CF, which is opposed to the array substrate AR. In the example illustrated, the second portion BMB of the light shield layer BM overlaps two color filters of the three color filters CFA, CFB and CFC. The second portion SEB of the shield electrode SE is stacked on that side of the second portion BMB, which is opposed to the array substrate AR. Incidentally, FIG. 8 shows the cross section cut along the first direction X and illustrates the second portion BMB of light shield layer BM and the second portion SEB of shield electrode SE. However, each of the light shield layer BM and shield electrode SE may include the first portion, as described above. The multilayer structure of the light shield layer BM and shield electrode SE is covered with the overcoat layer OC.

In this modification, too, the same advantageous effects as in the above-described examples can be obtained.

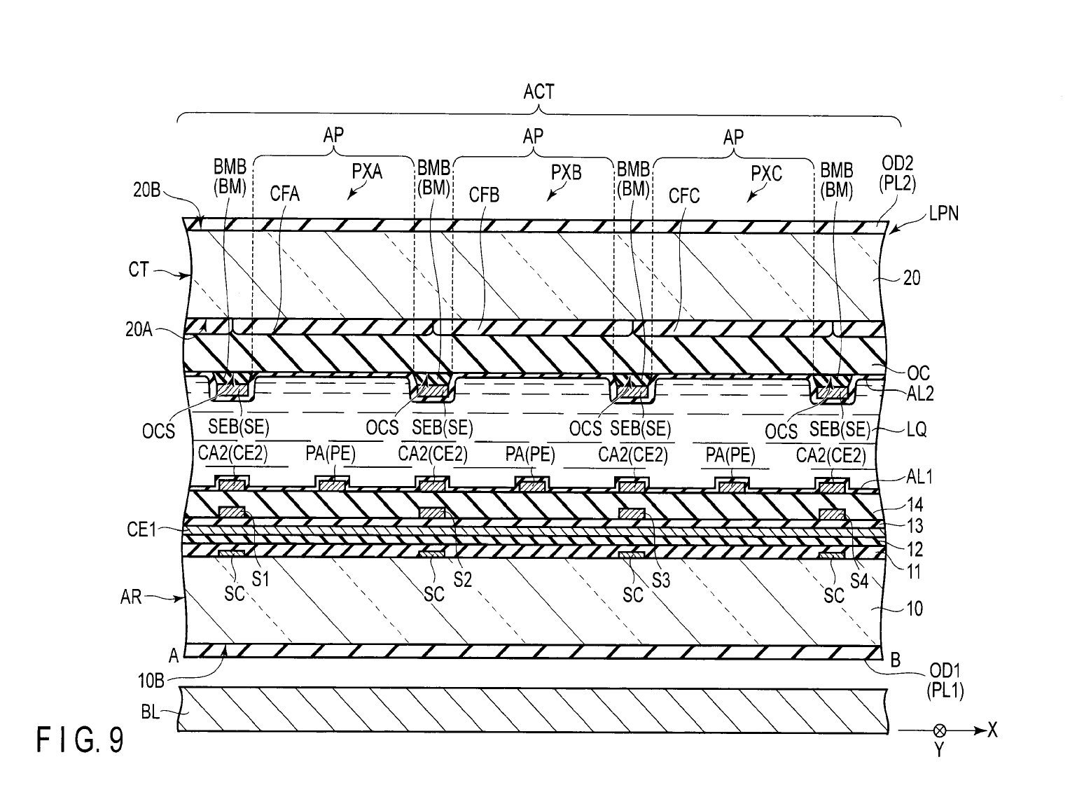

FIG. 9 is a cross-sectional view, taken along line A-B in FIG. 3, which schematically illustrates still another cross-sectional structure of the liquid crystal display panel LPN.

The example illustrated in FIG. 9 differs from the example in FIG. 4 in that the multilayer structure of the light shield layer BM and shield electrode SE is disposed between the overcoat layer OC and the second alignment film AL2.

Specifically, the light shield layer BM is disposed on an inner surface OCS of the overcoat layer OC, which is opposed to the array substrate AR. In the example illustrated, the second portion BMB of the light shield layer BM is located immediately below a boundary between two color filters of the three color filters CFA, CFB and CFC. The second portion SEB of the shield electrode SE is stacked on that side of the second portion BMB, which is opposed to the array substrate AR. The multilayer structure of the light shield layer BM and shield electrode SE is covered with the second alignment film AL2.

In this modification, too, the same advantageous effects as in the above-described examples can be obtained.

As in each of the above-described examples, it should suffice if the multilayer structure of the light shield layer BM and shield electrode SE is located on that side of the second insulative substrate 20, which is opposed to the array substrate AR, or is located between the second insulative substrate 20 and the second alignment film AL2.

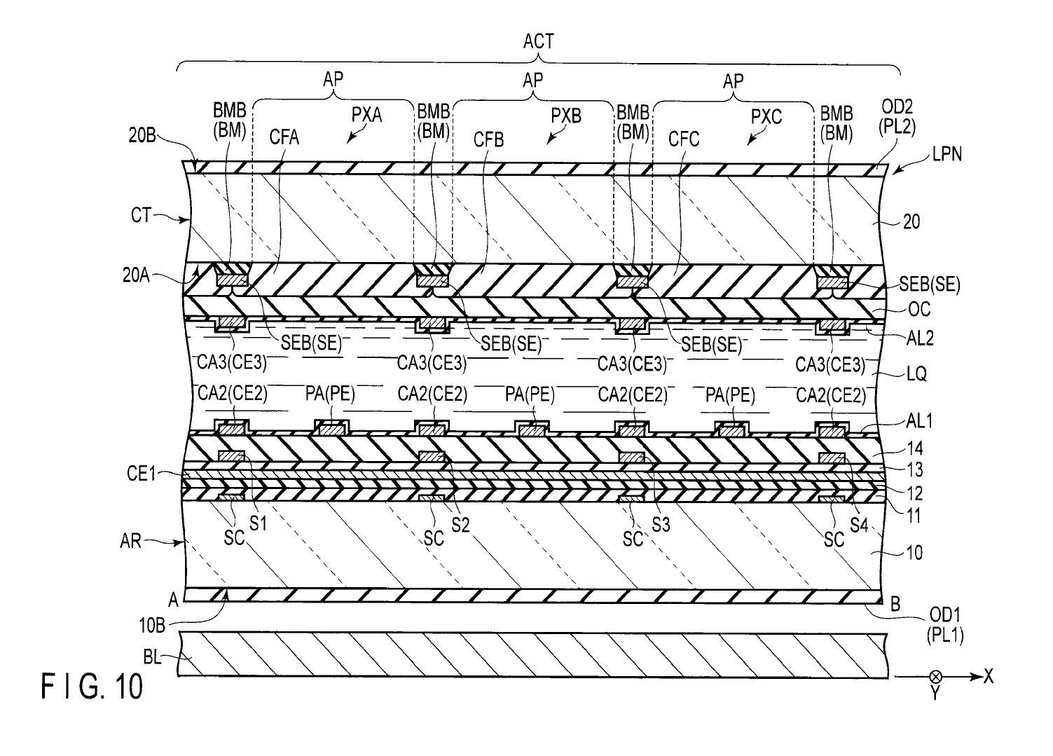

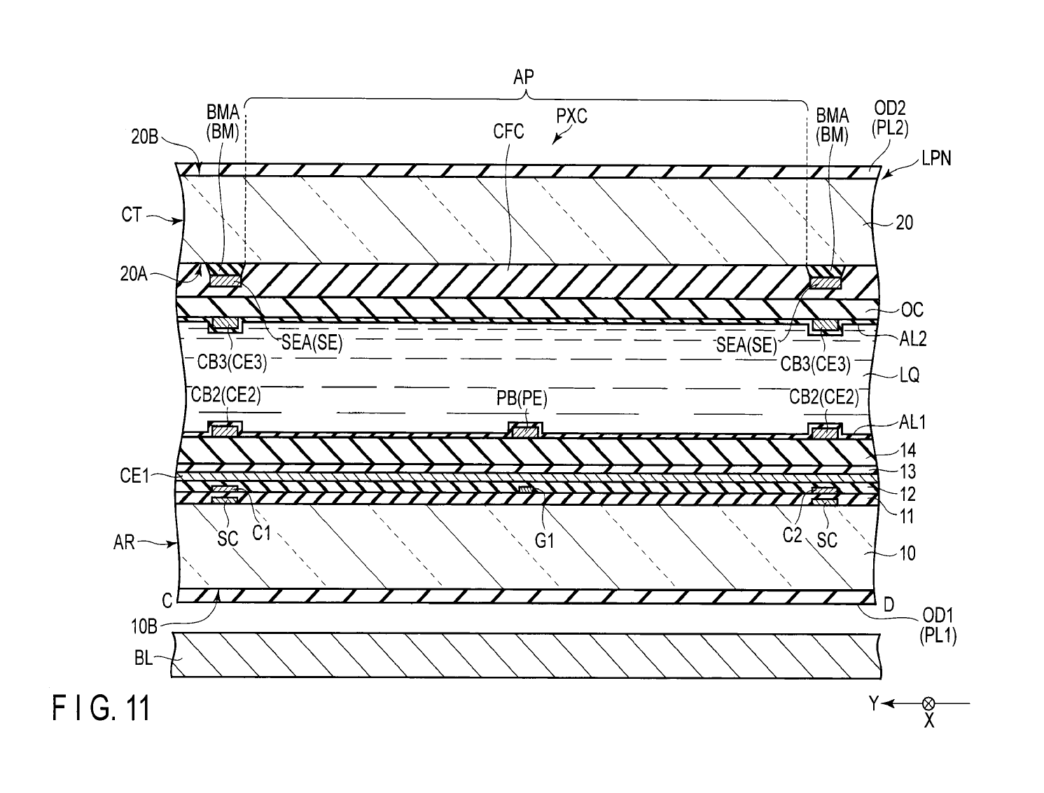

FIG. 10 is a cross-sectional view, taken along line A-B in FIG. 3, which schematically illustrates still another cross-sectional structure of the liquid crystal display panel LPN. FIG. 11 is a cross-sectional view, taken along line C-D in FIG. 3, which schematically illustrates another cross-sectional structure of the liquid crystal display panel LPN.

The example illustrated in FIG. 10 and FIG. 11 differs from the example illustrated in FIG. 4 and FIG. 5, in that the counter-substrate CT further includes a third common electrode CE3 as the common electrode CE.

Specifically, the third common electrode CE3 is disposed on that side of the light shield layer BM and shield electrode SE, which is opposed to the array substrate AR. In the example illustrated, the third common electrode CE3 is disposed on that side of the overcoat layer OC, which is opposed to the array substrate AR, and is covered with the second alignment film AL2. The third common electrode CE3 is formed of, for example, a transparent, electrically conductive material such as ITO or IZO. The third common electrode CE3 is electrically connected to the first common electrode CE1 and second common electrode CE2, and has the same potential as the first common electrode CE1 and second common electrode CE2.

The third common electrode CE3 includes third main common electrodes CA3 and third sub-common electrodes CB3. The third main common electrodes CA3 are located immediately below the second portions BMB of light shield layer BM and the second portions SEB of shield electrode SE, and are opposed to the second main common electrodes CA2. The third sub-common electrodes CB3 are located immediately below the first portions BMA of light shield layer BM and the first portions SEA of shield electrode SE, and are opposed to the second sub-common electrodes CB2. The third main common electrodes CA3 and third sub-common electrodes CB3 are formed integral or continuous, and are electrically connected to each other. Specifically, the third common electrode CE3 is formed in a grid shape which partitions the pixel PX.

In this modification, at the ON time, the alignment of liquid crystal molecules is controlled by an interaction between an electric field which is substantially parallel to the substrate major surface between the pixel electrode PE and second common electrode CE2, and an oblique electric field which is inclined to the substrate major surface between the pixel electrode PE and third common electrode CE3.

According to this modification, the same advantageous effects as in the above-described examples can be obtained. Furthermore, the third common electrode CE3 has the grid shape facing the second common electrode CE2, and has the same potential as the second common electrode CE2. Thus, an equipotential surface is formed between the second common electrode CE2 and third common electrode CE3. This equipotential surface keeps the liquid crystal molecules LM, which are located in the region immediately above the source line S, in the initial alignment state, regardless of the ON time or OFF time, even if misalignment occurs between the array substrate AR and counter-substrate CT. Therefore, the occurrence of color mixture can be suppressed.

In this modification, it is not always necessary that the shield electrode SE be set at a ground potential. A modification, in which a signal is applied to the shield electrode SE, will be described below.

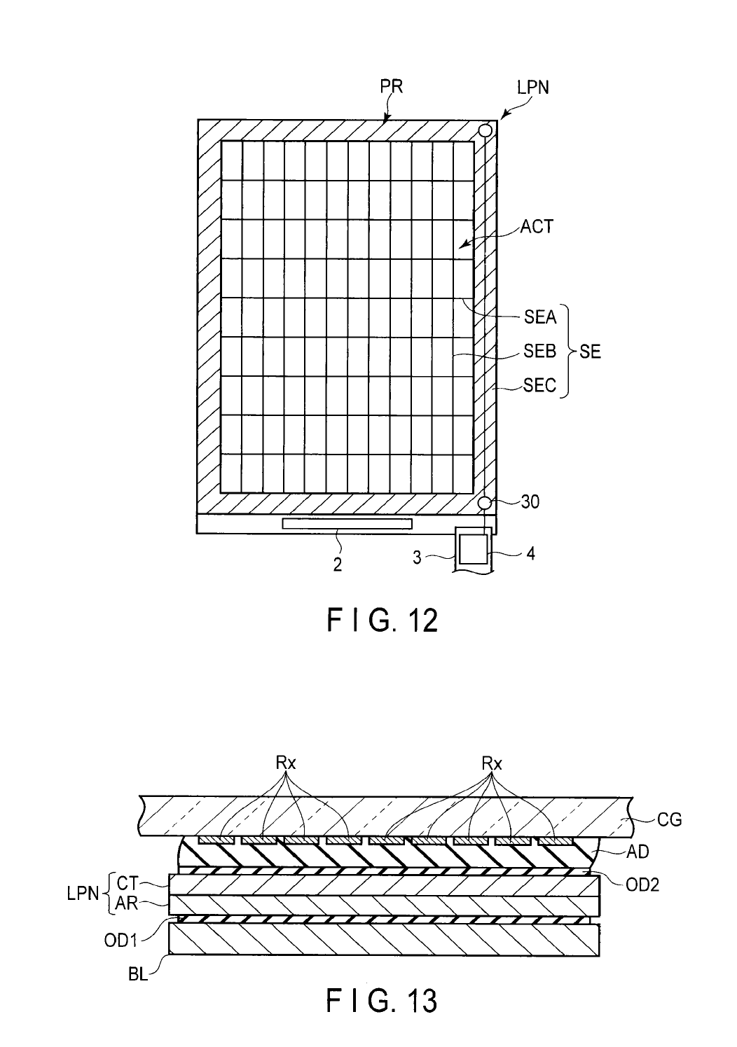

FIG. 12 is a plan view which schematically illustrates another example of the shield electrode SE, which is applicable to the modification illustrated in FIG. 10 and FIG. 11.

In the peripheral area PR, the shield electrode SE is electrically connected to the pad 30. In the example illustrated, the pad 30 is electrically connected to a signal source 4 that is mounted on the flexible printed circuit board 3. The signal source 4 outputs, for example, a noise cancel signal having a phase opposite to the phase of driving noise that may occur within the liquid crystal display panel LPN. Thereby, the noise cancel signal is applied to the shield electrode SE via the pad 30. For example, the signal source 4 may generate a noise cancel signal, based on various signals (video signal, control signal, etc.) which are supplied to the liquid crystal display panel LPN, or may generate a noise cancel signal, based on driving noise measured in the liquid crystal display panel LPN. Besides, the signal source 4 may generate a noise cancel signal which cancels only driving noise of a specific frequency band that adversely affects the peripheral equipment.

According to this modification, even if driving noise occurs within the liquid crystal display panel LPN, the noise cancel signal, which cancels driving noise, is applied to the shield electrode SE that is located on the display surface side, and thus the driving noise can be shielded. Therefore, the adverse effect on the peripheral equipment due to the driving noise can further be reduced.

Moreover, even in the case in which the noise cancel signal is applied to the shield electrode SE, the third common electrode CE3, which has the same potential as the second common electrode CE2, is disposed on that side of the shield electrode SE, which is opposed to the array substrate AR. Therefore, an undesired electric field due to the noise cancel signal is not applied to the liquid crystal layer LQ, and a disturbance in alignment of liquid crystal molecules LM can be suppressed.

Next, another modification is described.

FIG. 13 is a cross-sectional view which schematically illustrates the structure of a liquid crystal display device in a modification of the embodiment.

Specifically, the liquid crystal display device includes a liquid crystal display panel LPN, a backlight unit BL, and a cover glass CG with detection electrodes Rx. The structure of the liquid crystal display panel LPN is as described above, and a description thereof is omitted here. The backlight unit BL is disposed on a back surface side of the liquid crystal display panel LPN, that is, on an outer surface side of the array substrate AR. The cover glass CC is disposed on a front surface side of the liquid crystal display panel LPN, that is, on an outer surface side of the counter-substrate CT. This cover glass CG is attached to the liquid crystal display panel LPN by an adhesive AD such as an ultraviolet-curing resin.

The detection electrodes Rx are formed on that side of the cover glass CG, which is opposed to the liquid crystal display panel LPN. The detection electrodes Rx constitute a sensor which detects contact of an object with the cover glass CG, or approach of an object to the cover glass CG. As the sensor, for example, a capacitive sensing-type sensor is applicable. In the meantime, although capacitive sensing-type sensors can be classified into a self-capacitive sensing-type sensor, a mutual-capacitive sensing-type sensor, etc, the sensor in this modification may be any type sensor.

Incidentally, the detection electrodes Rx are not limited to the illustrated example. The detection electrodes Rx may be formed on a support substrate which is different from the cover glass CG, or may be formed on an outer surface of the counter-substrate CT.

According to this modification, while the shield electrode is provided, as described above, on the inner surface side of the counter-substrate CT, the detection electrodes Rx are disposed on the outer surface side of the counter-substrate CT. Therefore, without being affected by driving noise within the liquid crystal display panel LPN, the sensing of an object can be performed by the detection electrodes Rx, and the precision of sensing can be improved.

As has been described above, according to the present embodiment, there can be provided a liquid crystal display device which can reduce the effect of noise, without causing degradation in display quality.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiment described herein may be made without departing from the spirit of the invention. The accompanying claims and their equivalents are intended to cover such forms or modifications as would fall within the scope and spirit of the inventions.

What is claimed is:

1. A liquid crystal display device comprising:
a first substrate including a first insulative substrate, a gate line extending in a first direction, a source line extending in a second direction crossing the first direction, a switching element electrically connected to the gate line and the source line, a pixel electrode disposed in each of pixels and electrically connected to the switching element, and a common electrode disposed over a plurality of pixels;
a second substrate including a second insulative substrate, a light shield layer disposed on that side of the second insulative substrate, which is opposed to the first substrate, and partitioning the pixels, and a shield electrode stacked on that side of the light shield layer, which is opposed to the first substrate, and formed of a metallic material; and
a liquid crystal layer held between the first substrate and the second substrate.

2. The liquid crystal display device of claim 1, wherein the first substrate further includes a pad of a ground potential, and an electrically conductive member configured to electrically connect the pad and the shield electrode.

3. The liquid crystal display device of claim 1, wherein the common electrode includes a first common electrode located on the first insulative substrate side of the source line, and a second common electrode including a second main common electrode located on the liquid crystal layer side of the source line and opposed to the source line.

4. The liquid crystal display device of claim 3, wherein the first common electrode is opposed to the source line, extends in the first direction, is opposed to the gate line, and extends in the second direction.

5. The liquid crystal display device of claim 3, wherein the first common electrode is opposed to the pixel electrode.

6. The liquid crystal display device of claim 3, wherein the second common electrode is formed in a grid shape surrounding the pixel electrode.

7. The liquid crystal display device of claim 1, wherein the shield electrode is formed in a grid shape surrounding the pixel electrode, in a plane defined by the first direction and the second direction.

8. The liquid crystal display device of claim 1, wherein the second substrate further includes a third common electrode disposed on that side of the shield electrode, which is opposed to the first substrate.

9. The liquid crystal display device of claim 8, further comprising a signal source configured to apply to the shield electrode a noise cancel signal having a phase opposite to a phase of driving noise.

10. The liquid crystal display device of claim 1, further comprising, on an outer surface side of the second substrate, a detection electrode configured to detect contact or approach of an object.

11. The liquid crystal display device of claim 1, wherein the light shield layer is formed of a resin material which is colored in black.

12. The liquid crystal display device of claim 1, wherein the light shield layer is disposed on an inner surface of the second insulative substrate, which is opposed to the first substrate, and
the second substrate further includes a color filter disposed on the inner surface of the second insulative substrate, the color filter including a portion overlapping the shield electrode.

13. The liquid crystal display device of claim 1, wherein the second substrate further includes a color filter disposed on an inner surface of the second insulative substrate, which is opposed to the first substrate, and an overcoat layer covering the color filter, and
the light shield layer is disposed on an inner surface of the color filter, which is opposed to the first substrate, and the light shield layer and the shield electrode are covered with the overcoat layer.

14. The liquid crystal display device of claim 1, wherein the second substrate further includes a color filter disposed on an inner surface of the second insulative substrate, which is opposed to the first substrate, an overcoat layer covering the color filter, and an alignment film covering the overcoat layer, and
the light shield layer is disposed on an inner surface of the overcoat layer, which is opposed to the first substrate, and the light shield layer and the shield electrode are covered with the alignment film.

15. A liquid crystal display device comprising:
a first substrate including a first insulative substrate, a semiconductor layer, a first insulation film covering the semiconductor layer, a gate line extending in a first direction above the first insulation film, a second insulation film covering the gate line, a first common electrode formed above the second insulation film, a third insulation film covering the first common electrode, a source line extending in a second direction above the third insulation film, a fourth insulation film covering the source line, a pixel electrode including a main pixel electrode extending in the second direction above the fourth insulation film, and a second common electrode extending in the second direction above the fourth insulation film, including a second main common electrode opposed to the source line, and having the same potential as the first common electrode;
a second substrate including a second insulative substrate, a light shield layer disposed on that side of the second insulative substrate, which is opposed to the first substrate, and partitioning the pixels, and a shield electrode stacked on that side of the light shield layer, which is opposed to the first substrate, and formed of a metallic material; and
a liquid crystal layer held between the first substrate and the second substrate.

16. The liquid crystal display device of claim 15, wherein the first to third insulation films are formed of an inorganic material, and the fourth insulation film is formed of an organic material.

17. The liquid crystal display device of claim 15, wherein the first common electrode is opposed to the source line, extends in the first direction, is opposed to the gate line, and extends in the second direction.

18. The liquid crystal display device of claim 15, wherein the first common electrode is opposed to the pixel electrode.

19. The liquid crystal display device of claim 15, wherein the second common electrode is formed in a grid shape surrounding the pixel electrode.

20. The liquid crystal display device of claim 15, wherein the shield electrode is formed in a grid shape surrounding the pixel electrode, in a plane defined by the first direction and the second direction.

21. The liquid crystal display device of claim 15, wherein the light shield layer is disposed on an inner surface of the second insulative substrate, which is opposed to the first substrate, and
the second substrate further includes a color filter disposed on the inner surface of the second insulative substrate, the color filter including a portion overlapping the shield electrode.

22. The liquid crystal display device of claim 15, wherein the second substrate further includes a color filter disposed on an inner surface of the second insulative substrate, which is opposed to the first substrate, and an overcoat layer covering the color filter, and
the light shield layer is disposed on an inner surface of the color filter, which is opposed to the first substrate, and the light shield layer and the shield electrode are covered with the overcoat layer.

23. The liquid crystal display device of claim 15, wherein the second substrate further includes a color filter disposed on an inner surface of the second insulative substrate, which is opposed to the first substrate, an overcoat layer covering the color filter, and an alignment film covering the overcoat layer, and
the light shield layer is disposed on an inner surface of the overcoat layer, which is opposed to the first substrate, and the light shield layer and the shield electrode are covered with the alignment film.
